(19) United States
(12) Patent Application Publication
(10) Pub. No.: US 2005/0062708 A1
(43) Pub. Date: Mar. 24, 2005

(54) Liquid crystal display device

(75) Inventors: Toshiaki Yoshihara, Kawasaki (JP); Tetsuya Makino, Kawasaki (JP); Shinji Tadaki, Kawasaki (JP); Hironori Shiroto, Kawasaki (JP); Yoshinori Kiyota, Kawasaki (JP); Shigeo Kasahara, Kawasaki (JP); Keiichi Betsui, Kawasaki (JP)

Correspondence Address: GREER, BURNS & CRAIN, 300 S WACKER DR, 25TH FLOOR, CHICAGO, IL, 60606, US

(73) Assignee: FUJITSU LIMITED

(21) Appl. No.: 10/783,440

(22) Filed: Feb. 20, 2004

(30) Foreign Application Priority Data
Sep. 19, 2003 (JP) 2003-328667

(51) Int. Cl. G09G 3/36

(52) U.S. Cl. 345/96

(57) ABSTRACT

In a sub-frame of each color, the time required for each data scanning is 25% of the sub-frame, and the time between two times of data scanning is also 25% of the sub-frame. In a sub-frame of each color, a back-light is turned on between the intermediate timing in the first (first-half) data scanning and the intermediate timing in the second (second-half) data scanning. The ON time of the back-light is 50% of the sub-frame, and the ratio of time (panel ON rate) in which a liquid crystal panel is in a transmission state (ON) to the time in which the back-light is turned on is 88%, and thus high light utilization efficiency is achieved.

### BACKGROUND OF THE INVENTION

The present invention relates to field-sequential type or color-filter type liquid crystal display devices having a back-light as a light source for display.

Along with the recent development of so-called information-oriented society, electronic apparatuses, such as personal computers and PDA (Personal Digital Assistants), have been widely used. With the spread of such electronic apparatuses, portable apparatuses that can be used in offices as well as outdoors have been used, and there are demands for small-size and light-weight of these apparatuses. Liquid crystal display devices are widely used as one of the means to satisfy such demands. Liquid crystal display devices not only achieve small size and light weight, but also include an indispensable technique in an attempt to achieve low power consumption in portable electronic apparatuses that are driven by batteries.

The liquid crystal display devices are mainly classified into the reflection type and the transmission type. In the reflection type liquid crystal display devices, light rays incident from the front face of a liquid crystal panel are reflected by the rear face of the liquid crystal panel, and an image is visualized by the reflected light; whereas in the transmission type liquid crystal display devices, the image is visualized by the transmitted light from a light source (back-light) placed on the rear face of the liquid crystal panel. Since the reflection type liquid crystal display devices have poor visibility because the reflected light amount varies depending on environmental conditions, transmission type color liquid crystal display devices using color filters are generally used as display devices of personal computers for displaying full-color images.

As the color liquid crystal display devices, active-driven liquid crystal display devices using switching elements such as a TFT (Thin Film Transistor) are widely used. Although the TFT-driven type liquid crystal display devices have better display quality, they require a high brightness back-light to achieve high screen brightness because the light transmittance of the liquid crystal panel is only several percent or so at present. For this reason, a lot of power is consumed by the back-light. Moreover, since a color display is achieved using color filters, a single pixel needs to be composed of three sub-pixels, and there are problems that it is difficult to provide a high-resolution display, and the purity of the displayed colors is not sufficient.

In order to solve such problems, the present inventor et al. developed field-sequential type liquid crystal display devices (see, for example, T. Yoshihara, et. al., ILCC 98, P1-074, 1998; T. Yoshihara, et. al., AM-LCD '99 Digest of Technical Papers, p. 185, 1999; and T. Yoshihara, et. al., SID '00 Digest of Technical Papers, p.1176, 2000). Such field-sequential type liquid crystal display devices do not require sub-pixels, and therefore higher resolution displays can be easily realized compared to color-filter type liquid crystal display devices. Moreover, since a field-sequential type liquid crystal display device can use the color of light emitted by the light source as it is for display without using a color filter, the displayed color has excellent purity. Furthermore, since the light utilization efficiency is high, a field-sequential type liquid crystal display device has the advantage of low power consumption. However, in order to realize a field-sequential type liquid crystal display device, high-speed responsiveness (2 ms or less) of liquid crystal is essential.

In order to provide a field-sequential type liquid crystal display device with significant advantages as mentioned above or increase the speed of response of a color-filter type liquid crystal display device, the present inventor et al. are conducting research and development on the driving of liquid crystals such as a ferroelectric liquid crystal having spontaneous polarization, which may achieve 100 to 1000 times faster response compared to a prior art, by a switching element such as a TFT (for example, Japanese Patent Application Laid-Open No. 11-119189/1999). In the ferroelectric liquid crystal, the long-axis direction of the liquid crystal molecules tilts with the application of voltage. A liquid crystal panel sandwiching the ferroelectric liquid crystal therein is sandwiched by two polarization plates whose polarization axes are orthogonal to each other, and the intensity of the transmitted light is changed using birefringence caused by the change in the long-axis direction of the liquid crystal molecules. For such a liquid crystal display device, a ferroelectric liquid crystal having half-V-shaped electro-optic response characteristics with respect to the applied voltage as shown in FIG. 1, or a ferroelectric liquid crystal having V-shaped electro-optic response characteristics with respect to the applied voltage as shown in FIG. 2, is generally used as a liquid crystal material.

FIG. 3 shows an example of the drive sequence for a conventional field-sequential type liquid crystal display device, wherein FIG. 3(a) shows the scanning timing of each line of the liquid crystal panel, and FIG. 3(b) shows the ON timing of red, green and blue colors of the back-light. One frame is divided into three sub-frames, and, for example, as shown in FIG. 3(b), red light is emitted in the first sub-frame, green light is emitted in the second sub-frame, and blue light is emitted in the third sub-frame.

Meanwhile, as shown in FIG. 3(a), for the liquid crystal panel, two times of image data writing scanning are performed within a sub-frame of each of red, green and blue colors. In the first data scanning, data scanning is performed with a polarity capable of realizing a bright display. In the second data scanning, a voltage having a polarity opposite to that in the first data scanning and substantially equal magnitude is applied. Consequently, a darker display can be realized compared to the first data scanning, and the display is recognized as a substantially “black image”.

FIG. 4 shows another example of the drive sequence for a conventional field-sequential type liquid crystal display device, wherein FIG. 4(a) shows the scanning timing of each line of the liquid crystal panel, and FIG. 4(b) shows the ON timing of red, green and blue colors of the back-light. Red light, green light, and blue light are emitted sequentially in the respective sub-frames obtained by dividing one frame, and two times of image data writing scanning are performed within a sub-frame of each of red, green and blue colors. However, the time required for the data scanning is made shorter compared to the example of FIG. 3, and, instead of turning on the back-light all the time in the sub-frame as shown in FIG. 3(b), the back-light is turned on in synchronism with the start timing of the first data scanning and the back light is turned off in synchronism with the end timing of the second data scanning, i.e., the back-light is turned on between the start timing of data scanning for obtaining a bright display and the end timing of data scanning for obtaining a dark display, thereby reducing power consumption.

Although field-sequential type liquid crystal display devices have the advantages that the light utilization efficiency is high and a reduction in power consumption is possible, a further reduction in power consumption is required for the installation into portable apparatuses. Such a reduction in power consumption is required not only for field-sequential type liquid crystal display devices, but also for color-filter type liquid crystal display devices.

### BRIEF SUMMARY OF THE INVENTION

The present invention has been made with the aim of solving the above problems, and it is an object of the present invention to provide a liquid crystal display device capable of improving the utilization efficiency of light from a back-light and reducing power consumption.

A liquid crystal display device according to a first aspect of the present invention is a liquid crystal display device which synchronizes control of turning on a light source for emitting light to be incident on a liquid crystal panel with data scanning based on image data to be displayed on the liquid crystal panel in each predetermined period, wherein the light source is turned on between corresponding timings in the respective beginning scanning of one or a plurality of times of first-half data scanning and one or a plurality of times of second-half data scanning within the predetermined period.

In the liquid crystal display device of the first aspect, the light source (back-light) is turned on between a timing in the beginning scanning of one or a plurality of times of first-half data scanning within a predetermined period (one frame or one sub-frame) and a timing in the beginning scanning of one or a plurality of times of second-half data scanning within the predetermined period (one frame or one sub-frame) corresponding to the above-mentioned timing. Consequently, the light utilization efficiency is increased as explained below, and the power consumption of the light source (back-light) is reduced.

FIGS. 5A through 5D are illustrations for explaining the panel ON rate (the ratio of the time in which the liquid crystal panel is in a transmission state (ON) to the time in which the back-light is turned on) by the liquid crystal panel scanning and the back-light ON period, wherein FIGS. 5A and 5B show conventional examples, and FIGS. 5C and 5D show examples of the present invention. In the conventional examples, the back-light is turned on between the start timing of the first-half data scanning and the end timing of the second-half data scanning. Whereas in the examples of the present invention, the back-light is turned on between the intermediate timing in the first-half data scanning and the intermediate timing in the second-half data scanning.

As shown in the example of FIG. 5A, when the time required for data scanning is 50% of one frame or one sub-frame, the panel ON rate is as low as 50%, and the light utilization efficiency is low. On the other hand, as shown in the example of FIG. 5B, when the time required for data scanning is 25% of one frame or one sub-frame, the panel ON rate can be increased to 67%, but this value is not sufficient. In contrast, according to the present invention, as shown in the example of FIG. 5C, even when the time required for data scanning is 50% of one frame or one sub-frame, the panel ON rate is as high as 75%. Furthermore, as shown in the example of FIG. 5D, when the time required for data scanning is 25% of one frame or one sub-frame, the panel ON rate can be increased to 88%. As described above, according to the first aspect, since a very high panel ON rate can be realized, it is possible to increase the light utilization efficiency and reduce the power consumption.

According to a liquid crystal display device of a second aspect of the present invention, in the first aspect, the corresponding timing is a substantially intermediate time point in the respective beginning scanning. In the liquid crystal display device of the second aspect, the timing of starting to turn on the light source (back-light) and the timing of ending the turning on of the light source are the substantially intermediate time point of data scanning. Consequently, the brightness inclination is substantially symmetrical between the higher and lower sides of the liquid crystal panel in a data scanning direction, and the brightness inclination is reduced, thereby achieving a good display compared to the case where the timing of starting to turn on the light source (back-light) and the timing of ending the turning on of the light source are not the intermediate time point of data scanning.

According to a liquid crystal display device of a third aspect of the present invention, in the first or second aspect, a voltage applied to the liquid crystal panel in one or a plurality of times of first-half data scanning and a voltage applied to the liquid crystal panel in one or a plurality of times of second-half data scanning are equal in magnitude and opposite in polarity. In the liquid crystal display device of the third aspect, the voltages applied to the liquid crystal display elements in one or a plurality of times of first-half data scanning and one or a plurality of times of second-half data scanning are made equal in magnitude and opposite in polarity. Consequently, the inclination of the voltage applied to the liquid crystal is reduced, and image sticking on the display is prevented.

According to a liquid crystal display device of a fourth aspect of the present invention, in any one of the first through third aspects, a darker display is obtained by one or a plurality of times of second-half data scanning compared to one or a plurality of times of first-half data scanning. In the liquid crystal display device of the fourth aspect, when the liquid crystal material has half-V-shaped electro-optic response characteristics as shown in FIG. 1, after performing one or a plurality of times of first-half data scanning for obtaining a bright display, one or a plurality of times of second-half data scanning for obtaining a darker display than the bright display is performed. Accordingly, particularly, in a field sequential method, in a sub-frame of each color, since a dark display is performed after a bright display, it is possible to prevent mixing of colors on the display. On the other hand, in a sub-frame of each color, when a bright display is performed after a dark display, mixing of colors occurs toward the downstream of scanning during line scanning, and a color different from a desired displayed color is displayed, but the fourth aspect can prevent such an incident.

According to a liquid crystal display device of a fifth aspect of the present invention, in any one of the first through fourth aspects, the brightness distribution of the light source is uneven in a data scanning direction. In the liquid crystal display device of the fifth aspect, the brightness distribution of the light source is made uneven in the data scanning direction, and the brightness distribution of the light source (back-light) is adjusted according to the brightness inclination of the display image which occurs according to the timings of turning on and off the light source (back-light), thereby realizing a display image without a variation in brightness.

According to a liquid crystal display device of a sixth aspect of the present invention, in the fifth aspect, the brightness of the light source is lowest in the center in the data scanning direction and increases from the center toward upstream and downstream in the data scanning direction. In the liquid crystal display device of the sixth aspect, the brightness of the light source (back-light) is lowest in the center in the data scanning direction and increases from the center toward upstream and downstream in the data scanning direction. When the timings of turning on and off the light source (back-light) are the substantially intermediate time points of data scanning, the brightness inclination becomes symmetrical between the higher and lower sides of the liquid crystal panel in the data scanning direction, and therefore the variation in the brightness of the display screen can be reduced by increasing the brightness from a region corresponding to the center in data scanning toward regions corresponding to upstream and downstream in the data scanning direction as in the sixth aspect. Since the brightness distribution of such a light source (back-light) is symmetrical, it is easy to design the light source.

According to a liquid crystal display device of a seventh aspect of the present invention, in the fifth aspect, the brightness of the light source is lowest in the center in the data scanning direction, increases from the center toward upstream and downstream in the data scanning direction, and is higher on downstream side than on upstream side. In the liquid crystal display device of the seventh aspect, the brightness of the light source is lowest in the center in the data scanning direction, increases from the center toward upstream and downstream in the data scanning direction, and is higher in a region corresponding to the downstream side of data scanning than in a region corresponding to the upstream side. By taking into account the responsiveness of the liquid crystal material, the influence of the light source (back-light) on the display screen is larger on the downstream side than on the upstream side of data scanning. Therefore, by making the brightness of the light source (back-light) higher on the downstream side than on the upstream side of scanning, it is possible to further reduce the variation in the brightness of the display screen.

A liquid crystal display device according to an eighth aspect of the present invention is a liquid crystal display device which synchronizes control of turning on a light source for emitting light to be incident on a liquid crystal panel with data scanning based on image data to be displayed on the liquid crystal panel in each predetermined period, wherein switching is made between a first method in which the light source is turned on between corresponding timings in respective beginning scanning of one or a plurality of times of first-half data scanning and one or a plurality of times of second-half data scanning within the predetermined period and a second method in which the light source is turned on between a start timing of beginning scanning of one or a plurality of times of first-half data scanning and an end timing of beginning scanning of one or a plurality of times of second-half data scanning within the predetermined period. In the liquid crystal display device of the eighth aspect, it is possible to switch between the first display method according to the above-described first aspect and the second display method described as the conventional example. It is therefore possible to switch between the first display method for reducing power consumption and the second display method for reducing the variation in the brightness of the display image, according to a user's demand, by a simple process of adjusting the ON period of the light source (back-light).

According to a liquid crystal display device of a ninth aspect of the present invention, in any one of the first through eighth aspects, a liquid crystal material for use in the liquid crystal panel has spontaneous polarization. In the liquid crystal display device of the ninth aspect, a material having spontaneous polarization is used as the liquid crystal material. With the use of the liquid crystal material having spontaneous polarization, since a high-speed response is possible, high moving image display characteristics can be realized and a field-sequential type display can be easily realized. In particular, by using a ferroelectric liquid crystal with a small spontaneous polarization value as the liquid crystal material having spontaneous polarization, driving by a switching element such as a TFT is easily performed.

According to a liquid crystal display device of a tenth aspect of the present invention, in any one of the first through ninth aspects, a color display is performed by a field sequential method by switching the color of light emitted by the light source in a time divided manner in synchronism with on/off driving of the switching element. By using the field sequential method, it is possible to provide a display realizing high resolution, high-speed response, high color purity display and high transmission rate.

According to a liquid crystal display device of an eleventh aspect of the present invention, in any one of the first through ninth aspects, a color display is performed by a color filter method by selectively transmitting white light from the light source through color filters of a plurality of colors. Since a display is performed by the color filter method, a color display can be easily realized.

In the present invention, since the light source (back-light) is turned on between corresponding timings in the respective beginning scanning of one or a plurality of times of first-half data scanning within a predetermined period (one frame or one sub-frame) and one or a plurality of times of second-half data scanning, it is possible to improve the light utilization efficiency in the field-sequential type and color-filter type liquid crystal display devices and realize liquid crystal display devices consuming less power.

The above and further objects and features of the invention will more fully be apparent from the following detailed description with accompanying drawings.

### BRIEF DESCRIPTION OF THE SEVERAL VIEWS OF THE DRAWINGS

FIG. 1 is an illustration showing an example of the electro-optic response characteristics of a liquid crystal material;

FIG. 2 is an illustration showing another example of the electro-optic response characteristics of a liquid crystal material;

FIG. 3 is an illustration showing the drive sequence for a liquid crystal display device of a conventional example;

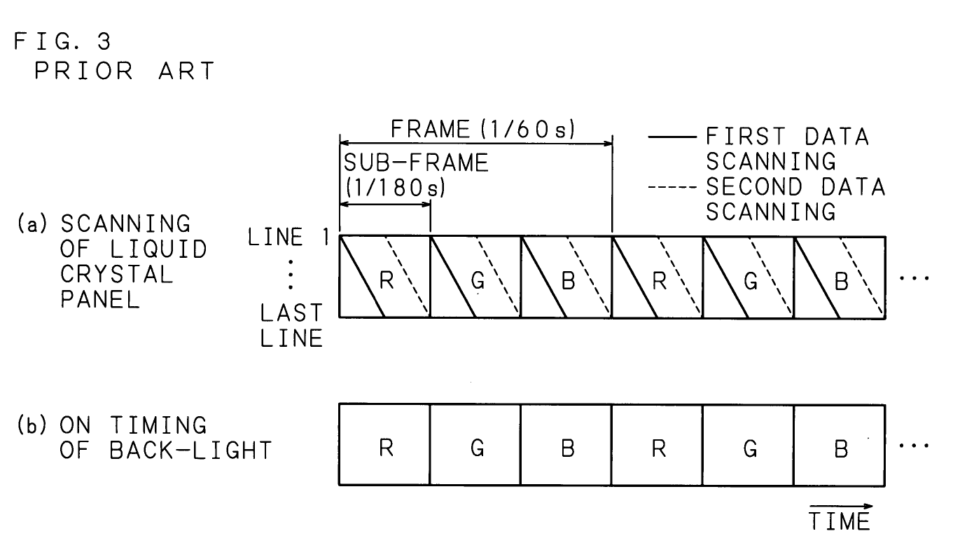

FIG. 4 is an illustration showing the drive sequence for a liquid crystal display device of a conventional example (the first comparative example);

FIGS. 5A through 5D are illustrations showing the panel ON rate by the liquid crystal panel scanning and the back-light ON period;

FIG. 6 is a block diagram showing the circuit structure of a liquid crystal display device according to the first through fourth embodiments;

FIG. 7 is a schematic cross sectional view of the liquid crystal panel and back-light of a field-sequential type liquid crystal display device;

FIG. 8 is a schematic view showing an example of the overall structure of the liquid crystal display device;

FIG. 9 is an illustration showing the drive sequence for a liquid crystal display device according to the first and third embodiments;

FIG. 10 is an illustration showing the drive sequence for a liquid crystal display device according to the second and fourth embodiments;

FIG. 11 is an illustration showing the drive sequence for a liquid crystal display device of a conventional example (the second comparative example);

FIG. 12 is an illustration showing the brightness distribution of the back-light in the liquid crystal display device of the third embodiment;

FIG. 13 is an illustration showing the brightness distribution of the back-light in the liquid crystal display device of the fourth embodiment;

FIG. 14 is a block diagram showing the circuit structure of a liquid crystal display device according to the fifth embodiment;

FIG. 15 is an illustration showing an example of the drive sequence for a liquid crystal display device of the present invention;

FIG. 16 is an illustration showing another example of the drive sequence for a liquid crystal display device of the present invention;

FIG. 17 is a schematic cross sectional view of the liquid crystal panel and back-light of a color-filter type liquid crystal display device; and

FIG. 18 is an illustration showing an example of the drive sequence for the color-filter type liquid crystal display device.

### DETAILED DESCRIPTION OF THE INVENTION

The following description will specifically explain the present invention with reference to the drawings illustrating some embodiments thereof. Note that the present invention is not limited to the following embodiments.

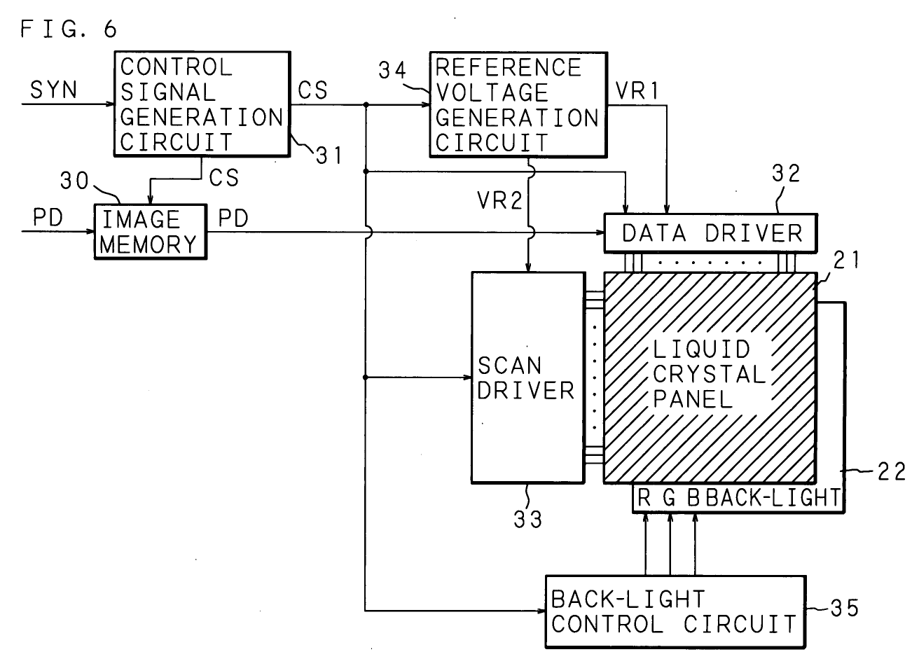

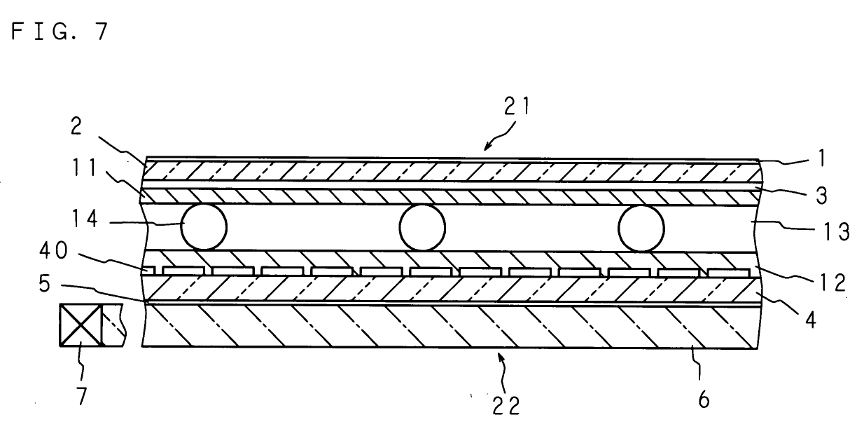

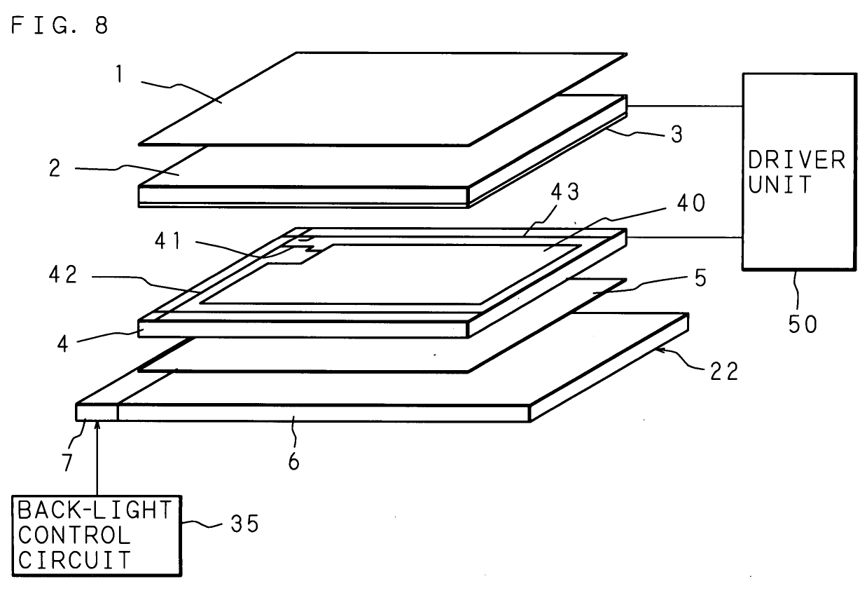

FIG. 6 is a block diagram showing the circuit structure of a liquid crystal display device according to the present invention (the first through fourth embodiments); FIG. 7 is a schematic cross sectional view of a liquid crystal panel and a back-light; and FIG. 8 is a schematic view showing an example of the overall structure of the liquid crystal display device.

In FIG. 6, the numerals 21 and 22 represent a liquid crystal panel and a back-light whose cross sectional structures are shown in FIG. 7. As shown in FIG. 7, the back-light 22 is composed of an LED array 7 and a light guiding/diffusing plate 6. As shown in FIGS. 7 and 8, the liquid crystal panel 21 comprises a polarization film 1, a glass substrate 2, a common electrode 3, a glass substrate 4 and a polarization film 5, which are stacked in this order from the upper layer (front face) side to the lower layer (rear face) side, and pixel electrodes 40 which are arranged in matrix form on the common electrode 3 side of the glass substrate 4.

A driver unit 50 comprising a data driver 32 and a scan driver 33 is connected between the common electrode 3 and the pixel electrodes 40. The data driver 32 is connected to TFTs 41 through signal lines 42, while the scan driver 33 is connected to the TFTs 41 through scanning lines 43. The TFTs 41 are controlled to be on/off by the scan driver 33. Moreover, each of the pixel electrodes 40 is connected to the TFT 41. Therefore, the intensity of transmitted light of each individual pixel is controlled by a signal given from the data driver 32 through the signal line 42 and the TFT 41.

An alignment film 12 is provided on the upper face of the pixel electrodes 40 on the glass substrate 4, while an alignment film 11 is placed on the lower face of the common electrode 3. The space between these alignment films 11 and 12 is filled with a liquid crystal material so as to form a liquid crystal layer 13. Note that the numeral 14 represents spacers for maintaining a layer thickness of the liquid crystal layer 13.

The back-light 22 is disposed on the lower layer (rear face) side of the liquid crystal panel 21, and has the LED array 7 placed to face an end face of the light guiding/diffusing plate 6 that forms a light emitting area. This LED array 7 comprises one or a plurality of LEDs, one LED chip being composed of LED elements that emit light of the three primary colors, namely red (R), green (G) and blue (B), on a face facing the light guiding/diffusing plate 6. The LED array 7 turns on the red, green and blue LED elements in red, green and blue sub-frames, respectively. The light guiding/diffusing plate 6 guides the light emitted from each LED of this LED array 7 to its entire surface, and diffuses the light to the upper face, thereby functioning as the light emitting area.

This liquid crystal panel 21 and the back-light 22 capable of emitting red, green and blue light in a time-divided manner are stacked one upon another. The ON timing and the color of emitted light of the back-light 22 are controlled in synchronism with data scanning of the liquid crystal panel 21 based on display data.

In FIG. 6, the numeral 31 is a control signal generation circuit to which a synchronous signal SYN is inputted from a personal computer, and which generates various control signals CS necessary for display. Pixel data PD is outputted from an image memory 30 to the data driver 32. Based on the pixel data PD and a control signal CS for changing the polarity of applied voltage, a voltage is applied to the liquid crystal panel 21 through the data driver 32.

Moreover, the control signal generation circuit 31 outputs a control signal CS to each of a reference voltage generation circuit 34, the data driver 32, the scan driver 33, and a back-light control circuit 35. The reference voltage generation circuit 34 generates reference voltages VR1 and VR2, and outputs the generated reference voltages VR1 and VR2 to the data driver 32 and the scan driver 33, respectively. The data driver 32 outputs signals to the signal lines 42 of the pixel electrodes 40, based on the pixel data PD from the image memory 30 and the control signals CS from the control signal generation circuit 31. In synchronism with the output of the signals, the scan driver 33 scans the scanning lines 43 of the pixel electrodes 40 sequentially on a line by line basis. Further, the back-light control circuit 35 applies a drive voltage to the back-light 22 so as to emit red light, green light, and blue light from the back-light 22.

Next, the operation of the liquid crystal display device will be explained. Pixel data PD for display is inputted to the image memory 30 from the personal computer. After storing the pixel data PD temporarily, the image memory 30 outputs the pixel data PD upon receipt of the control signal CS outputted from the control signal generation circuit 31. The control signal CS generated by the control signal generation circuit 31 is supplied to the data driver 32, scan driver 33, reference voltage generation circuit 34, and back-light control circuit 35. The reference voltage generation circuit 34 generates reference voltages VR1 and VR2 upon receipt of the control signal CS, and outputs the generated reference voltages VR1 and VR2 to the data driver 32 and the scan driver 33, respectively.

When the data driver 32 receives the control signal CS, it outputs a signal to the signal lines 42 of the pixel electrodes 40, based on the pixel data PD outputted from the image memory 30. When the scan driver 33 receives the control signal CS, it scans the scanning lines 43 of the pixel electrodes 40 sequentially on a line by line basis. According to the output of the signal from the data driver 32 and the scanning by the scan driver 33, the TFTs 41 are driven, and a voltage is applied to the pixel electrodes 40, thereby controlling the intensity of the transmitted light of the pixels. When the back-light control circuit 35 receives the control signal CS, it applies a drive voltage to the back-light 22 so as to cause the red, green and blue LED elements of the LED array 7 of the back-light 22 to emit light in a time-divided manner, thereby emitting red light, green light, and blue light sequentially with passage of time. Thus, a color display is performed by synchronizing control of turning on the back-light 22 (LED array 7) for emitting light incident on the liquid crystal panel 21 with a plurality of times of data scanning on the liquid crystal panel 21.

(First Embodiment)

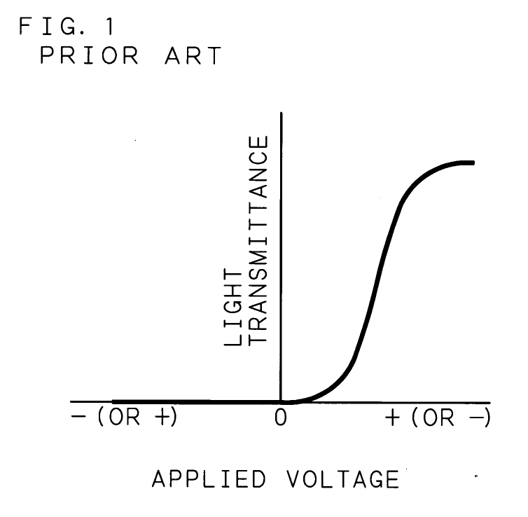

After washing a TFT substrate having pixel electrodes 40 (pixel number: 640×480, diagonal: 3.2 inches) and a glass substrate 2 having a common electrode 3, they were coated with polyimide and baked for one hour at 200° C. so as to form about 200 Å thick polyimide films as alignment films 11 and 12. Further, these alignment films 11 and 12 were rubbed with a rayon fabric, and an empty panel was produced by stacking these two substrates so that the rubbing directions are parallel and maintaining a gap therebetween by spacers 14 made of silica having an average particle size of 1.6 μm. A ferroelectric liquid crystal material composed mainly of naphthalene-based liquid crystal and having half-V-shaped electro-optic response characteristics as shown in FIG. 1 (for example, a material disclosed in A. Mochizuki, et. al.: Ferroelectrics, 133,353 (1991)) was sealed between the alignment films 11 and 12 of this empty panel so as to form a liquid crystal layer 13. The magnitude of spontaneous polarization of the sealed ferroelectric liquid crystal material was 6 nC/cm². The liquid crystal panel 21 was produced by sandwiching the fabricated panel by two polarization films 1 and 5 arranged in a crossed-Nicol state, and a dark state is provided when the long-axis direction of the ferroelectric liquid crystal molecules is tilted in one direction.

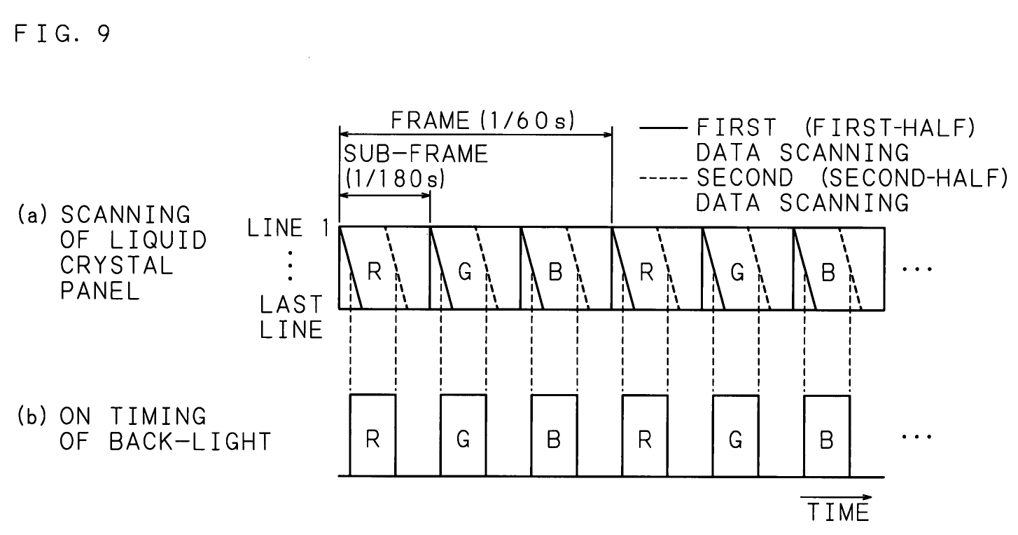

The liquid crystal panel 21 thus fabricated and the back-light 22 comprising the LED array 7 capable switching surface emission of monochrome colors, red, green and blue, as a light source were stacked one upon another, and a color display was performed by a field-sequential method, according to a drive sequence as shown in FIG. 9.

The frame frequency is set to 60 Hz, and one frame (period: 1/60 s) is divided into three sub-frames (period: 1/180 s). As shown in FIG. 9(a), for example, two times of writing scanning of red image are performed in the first sub-frame, two times of writing scanning of green image data are performed in the next second sub-frame, and two times of writing scanning of blue image data are performed in the last third sub-frame within one frame. In each sub-frame, the time required for each data scanning is 25% (1/720 s) of the sub-frame (1/180 s), and the time between the two times of data scanning is also 25% (1/720 s) of the sub-frame (1/180 s). Note that in the two times of data scanning in each sub-frame, the voltage applied to the liquid crystal of each pixel in the first (first-half) data scanning and the voltage applied to the liquid crystal of each pixel in the second (second-half) data scanning have opposite polarities and substantially equal magnitude. As a result, in the second (second-half) data scanning, a darker display that can be recognized as a substantially black image is obtained compared to the first (first-half) data scanning.

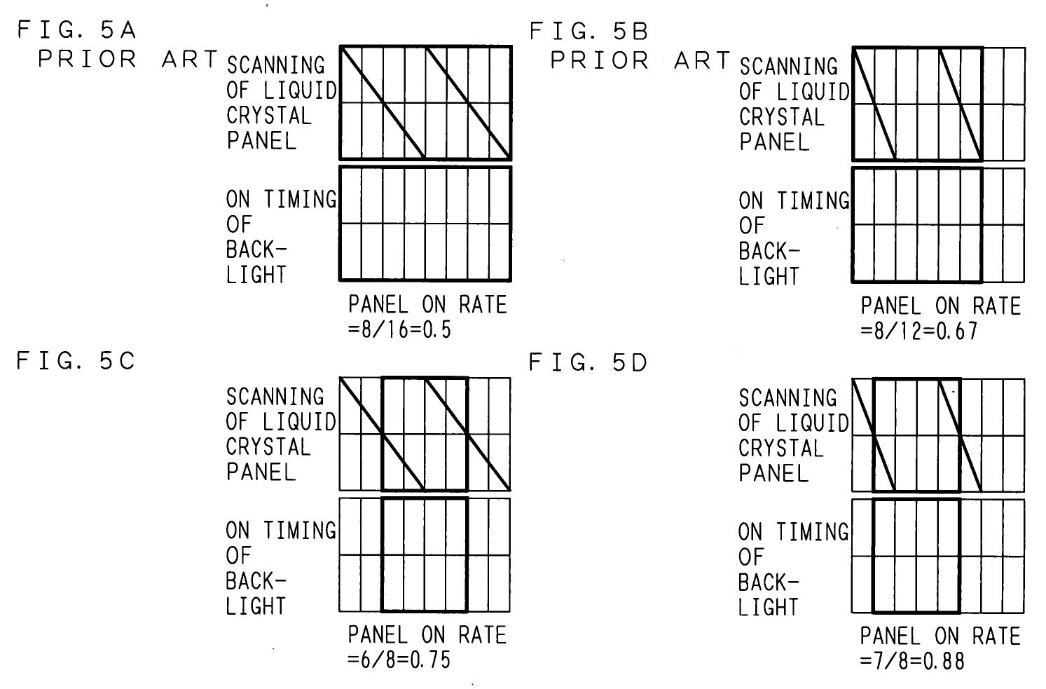

Meanwhile, turning of the red, green and blue light of the back-light 22 is controlled as shown in FIG. 9(b). In each sub-frame, the back-light 22 is turned on between corresponding timings in the respective first (first-half) data scanning and second (second-half) data scanning. In other words, the back-light 22 is turned on between the intermediate timing in the first (first-half) data scanning within one sub-frame and the intermediate timing in the second (second-half) data scanning within the one sub-frame. Accordingly, in each sub-frame, the ON time of the back-light 22 is 50% (1/360 s) of the sub-frame (1/180 s), and the panel ON rate representing the ratio of the transmission state (ON) of the liquid crystal panel 21 to the time in which the back-light 22 is turned on is 88% (see FIG. 5D).

As a result, a high-resolution, high-speed response, high color purity display is realized. The screen brightness is about 180 cd/cm² in the center of the liquid crystal panel 21 in the data scanning direction, about 135 cd/cm² in the top end, and about 125 cd/cm² in the bottom end. At this time, the power consumption of the back-light 22 is 0.9 W. Thus, a high brightness display and a reduction in power consumption are realized.

(First Comparative Example)

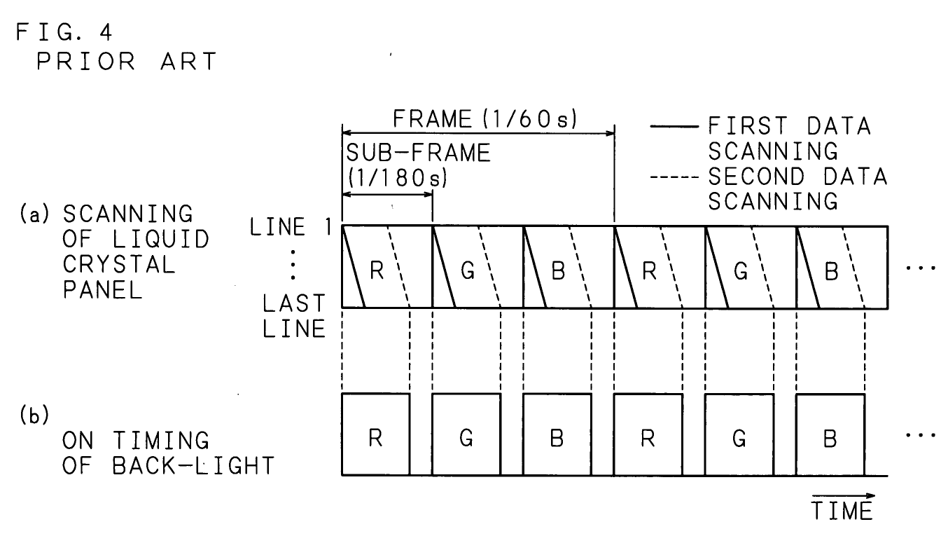

A liquid crystal panel fabricated in the same manner as in the first embodiment and a back-light similar to that in the first embodiment were stacked one upon another, and a color display was performed by a field-sequential method, according to a drive sequence as shown in FIG. 4 mentioned above.

As shown in FIG. 4(a), two times of data scanning in each sub-frame are the same as in the first embodiment (see FIG. 9(a)). On the other hand, turning of the red, green and blue light of the back-light 22 is controlled as shown in FIG. 4(b). In each sub-frame, the back-light is turned on between the start timing of the first (first-half) data scanning and the end timing of the second (second-half) data scanning. Accordingly, in each sub-frame, the ON time of the back-light is 75% (1/240 s) of the sub-frame (1/180 s), and the panel ON rate representing the ratio of the transmission state (ON) of the liquid crystal panel to the time in which the back-light is turned on is 67% (see FIG. 5B).

As a result, similarly to the first embodiment, a high-resolution, high-speed response, high color purity display is realized. The screen brightness is about 180 cd/cm² over the entire area of the liquid crystal panel. At this time, the power consumption of the back-light is 1.4 W, and thus more power is consumed compared to the first embodiment.

(Second Embodiment)

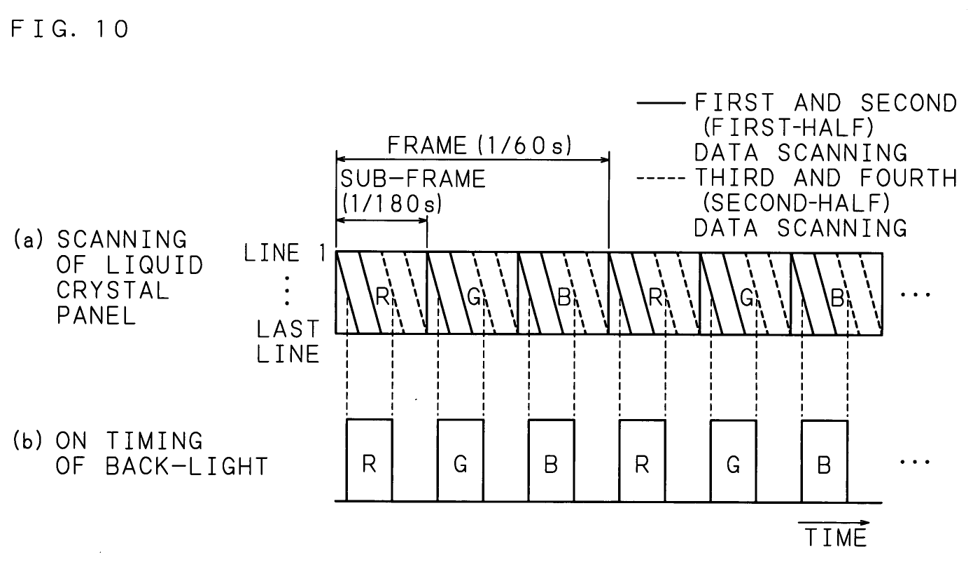

A liquid crystal panel 21 fabricated in the same manner as in the first embodiment and a back-light 22 similar to that in the first embodiment were stacked one upon another, and a color display was performed by a field sequential method, according to a drive sequence as shown in FIG. 10.

The frame frequency is set to 60 Hz, and one frame (period: 1/60 s) is divided into three sub-frames (period: 1/180 s). As shown in FIG. 10(a), for example, four times of writing scanning of red image data are performed in the first sub-frame, four times of writing scanning of green image data are performed in the next second sub-frame, and four times of writing scanning of blue image data are performed in the last third sub-frame within one frame. In each sub-frame, the time required for each data scanning is 25% (1/720 s) of the sub-frame (1/180 s), and the end timing of data scanning is set to coincide with the start timing of the next data scanning. Note that in the four times of data scanning in each sub-frame, the voltage applied to the liquid crystal of each pixel in the first and second (first-half) data scanning and the voltage applied to the liquid crystal of each pixel in the third and fourth (second-half) data scanning have opposite polarities and substantially equal magnitude. As a result, in the two times of second-half data scanning, a darker display that can be recognized as a substantially black image is obtained compared to the two times of first-half data scanning.

Meanwhile, turning of the red, green and blue light of the back-light 22 is controlled as shown in FIG. 10(b). In each sub-frame, the back-light 22 is turned on between corresponding timings in the respective beginning scanning of the two times of first-half data scanning and the two times of second-half data scanning. In other words, the back-light 22 is turned on between the intermediate timing in the beginning data scanning (first data scanning) in the two times of first-half data scanning within one sub-frame and the intermediate timing in the beginning data scanning (third data scanning) in the two times of second-half data scanning within the one sub-frame. Accordingly, in each sub-frame, the ON time of the back-light 22 is 50% (1/360 s) of the sub-frame (1/180 s), and the panel ON rate representing the ratio of the transmission state (ON) of the liquid crystal panel 21 to the time in which the back-light 22 is turned on is 88%.

As a result, a high-resolution, high-speed response, high color purity display is realized. By increasing the number of times of data scanning compared to the first embodiment, the screen brightness is improved to about 220 cd/cm² in the center of the liquid crystal panel 21 in the data scanning direction, about 165 cd/cm² in the top end, and about 155 cd/cm² in the bottom end. At this time, the power consumption of the back-light 22 is 0.9 W. Thus, a high brightness display and a reduction in power consumption are realized.

(Second Comparative Example)

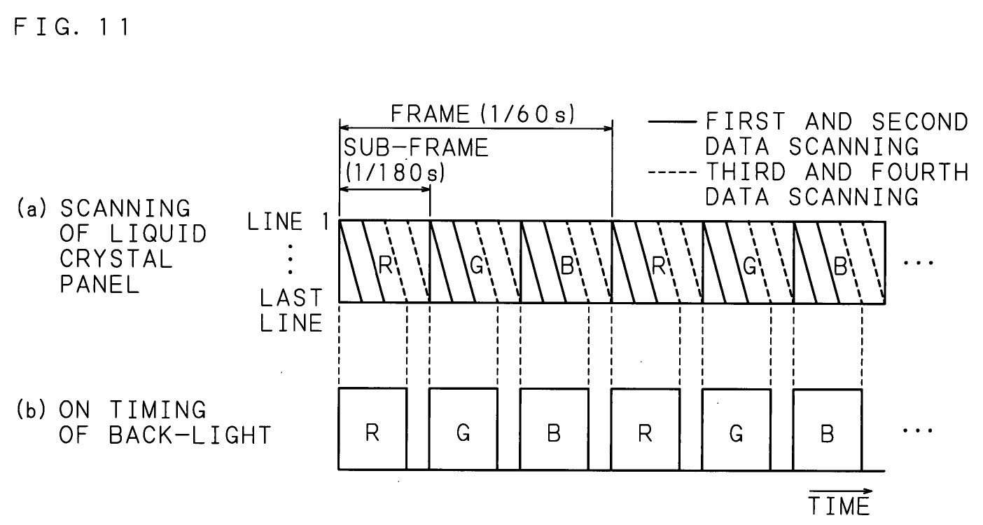

A liquid crystal panel fabricated in the same manner as in the first embodiment and a back-light similar to that in the first embodiment were stacked one upon another, and a color display was performed by a field-sequential method, according to a drive sequence as shown in FIG. 11.

As shown in FIG. 11(a), four times of data scanning in each sub-frame are the same as those in the second embodiment (see FIG. 10(a)). On the other hand, turning of the red, green and blue light of the back-light is controlled as shown in FIG. 11(b). In each sub-frame, the back-light is turned on between the start timing of the first data scanning and the end timing of the third data scanning. Accordingly, in each sub-frame, the ON time of the back-light is 75% (1/240 s) of the sub-frame (1/180 s), and the panel ON rate representing the ratio of the transmission state (ON) of the liquid crystal panel to the time in which the back-light is turned on is 67%.

As a result, similarly to the second embodiment, a high-resolution, high-speed response, high color purity display is realized. The screen brightness is about 220 cd/cm² over the entire area of the liquid crystal panel. At this time, the power consumption of the back-light is 1.4 W, and thus more power is consumed compared to the second embodiment.

(Third Embodiment)

A liquid crystal layer 13 was produced by sealing a mono-stable ferroelectric liquid crystal material having half-V-shaped electro-optic response characteristics as shown in FIG. 1 (for example, R2301 available from Clariant (Japan) K.K.) between the alignment films 11 and 12 of an empty panel fabricated by the same process as in the first embodiment. The magnitude of spontaneous polarization of the sealed ferroelectric liquid crystal material was 6 nC/cm². After sealing the liquid crystal material in the panel, a voltage of 10 V was applied at temperatures including the transition temperature from the cholesteric phase to the chiral smectic C phase, thereby realizing a uniform liquid crystal alignment state. The fabricated panel was sandwiched by two polarization films 1 and 5 arranged in a crossed-Nicol state so as to produce a liquid crystal panel 21, and a dark state was provided in the absence of applied voltage.

The liquid crystal panel 21 thus fabricated and a back-light 22 similar to that in the first embodiment were stacked one upon another, and a color display was performed by a field-sequential method, according to the same drive sequence as in the first embodiment shown in FIG. 9.

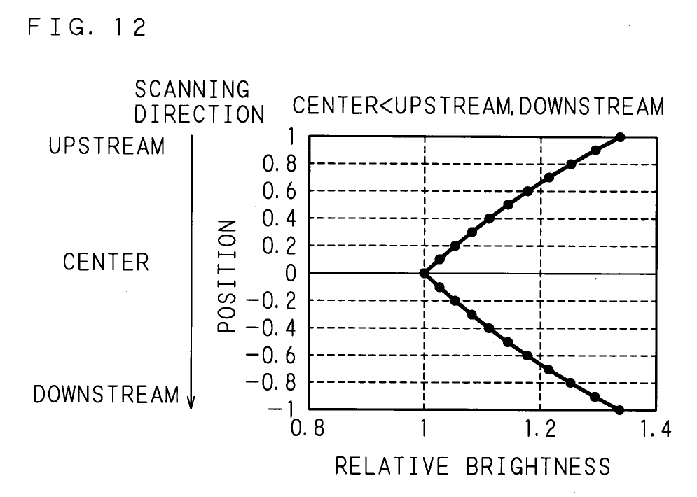

In each sub-frame, the timing of turning on the back-light 22 is the same as in the first embodiment (FIG. 9(b)), but the brightness distribution of the back-light 22 is not even and is uneven in the data scanning direction. More specifically, as shown in FIG. 12, the brightness of the back-light 22 is set to be the lowest in the center in the data scanning direction and increase from the center toward the upstream side and downstream side in the data scanning direction. The brightness distribution of the back-light 22 is symmetrical about the center in the data scanning direction, and the brightness in the upstream end and that in the downstream end are equal. Such an uneven brightness distribution is realized by adjusting the reflection characteristics of the light guiding/diffusing plate 6. Alternatively, an uneven brightness distribution may be realized by adjusting the arrangement of the LED elements of the LED array 7.

As a result, a high-resolution, high-speed response, high color purity display is realized. The screen brightness is about 160 cd/cm² in the center of the liquid crystal panel 21 in the data scanning direction, about 160 cd/cm² in the top end, and about 150 cd/cm² in the bottom end. At this time, the power consumption of the back-light 22 is 0.9 W Thus, a high brightness display and a reduction in power consumption are realized. Furthermore, the variation in brightness is reduced compared to the first and second embodiments.

(Fourth Embodiment)

A liquid crystal panel 21 fabricated in the same manner as in the third embodiment and a back-light 22 similar to that in the first embodiment were stacked one upon another, and a color display was performed by a field-sequential method, according to the same drive sequence as in the second embodiment shown in FIG. 10.

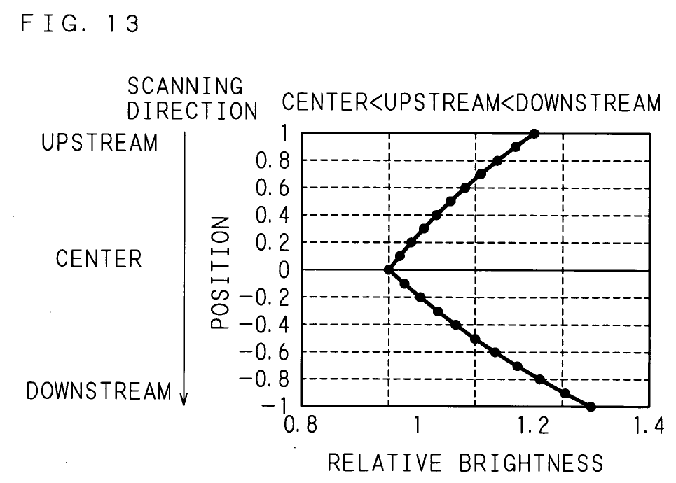

The timing of turning on the back-light 22 in each sub-frame is the same as in the second embodiment (FIG. 10(b)), but the brightness distribution of the back-light 22 is made uneven in the data scanning direction. More specifically, as shown in FIG. 13, the brightness of the back-light 22 is set to be the lowest in the center in the data scanning direction and increase from the center toward the upstream side and downstream side in the data scanning direction, and further the brightness of the back-light 22 is set higher in a region corresponding to the downstream side of data scanning than in a region corresponding to the upstream side. The brightness distribution of the back-light 22 is asymmetrical about the center in the data scanning direction, and the brightness in the downstream end is higher than the brightness in the upstream end. Similarly to the third embodiment, such an uneven brightness distribution is realized by adjusting the reflection characteristics of the light guiding/diffusing plate 6, or adjusting the arrangement of the LED elements of the LED array 7.

As a result, a high-resolution, high-speed response, high color purity display is realized. The screen brightness is about 200 cd/cm² in the center of the liquid crystal panel 21 in the data scanning direction, about 200 cd/cm² in the top end, and about 200 cd/cm² in the bottom end. At this time, the power consumption of the back-light 22 is 0.9 W. Thus, a high brightness display and a reduction in power consumption are realized. Furthermore, the variation in brightness is reduced compared to the first, second and third embodiments.

(Fifth Embodiment)

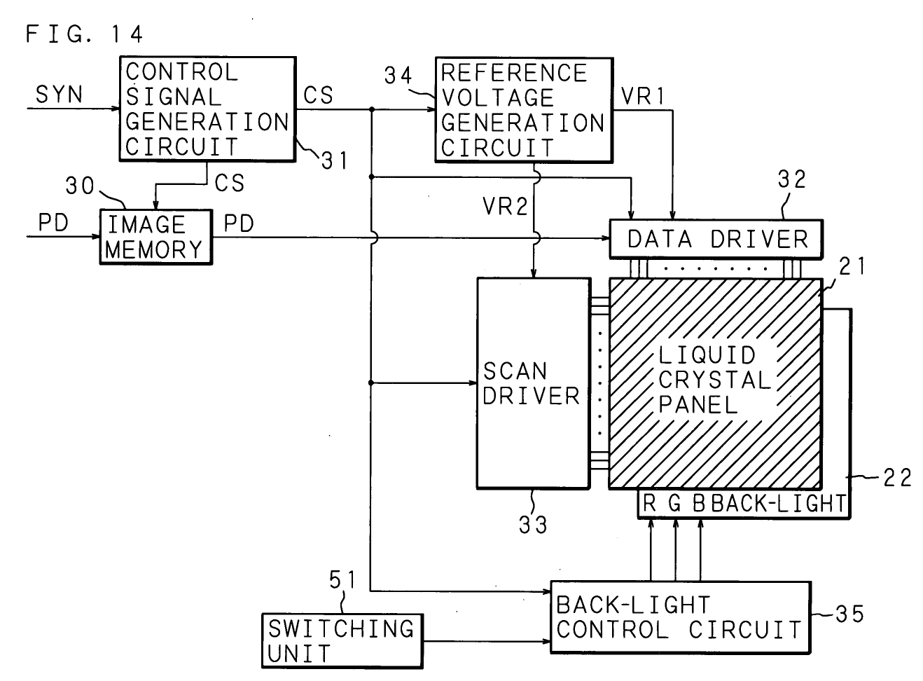

FIG. 14 is a block diagram showing the circuit structure of a liquid crystal display device according to the fifth embodiment. In FIG. 14, the same parts as in FIG. 6 are designated with the same numbers, and the explanation thereof is omitted.

In the fifth embodiment, it is possible to execute a first display method in which the timing of turning on the back-light 22 is controlled as described in the first through fourth embodiments, and a second display method in which the timing of turning on the back-light 22 is controlled as described in the first and second comparative examples (conventional examples). Switching between the first display method and second display method is made by a user's operating input to a switching unit 51. Therefore, switching between the first display method for reducing the power consumption and the second display method for reducing the variation in the brightness of display images can be easily made by switching the timing of turning on the back-light 22.

Note that in the above-mentioned example, the time ratio of one data scanning to one sub-frame is 25%, but a further improvement in the light utilization efficiency and a further reduction in the variation in brightness can be achieved by further decreasing this time ratio.

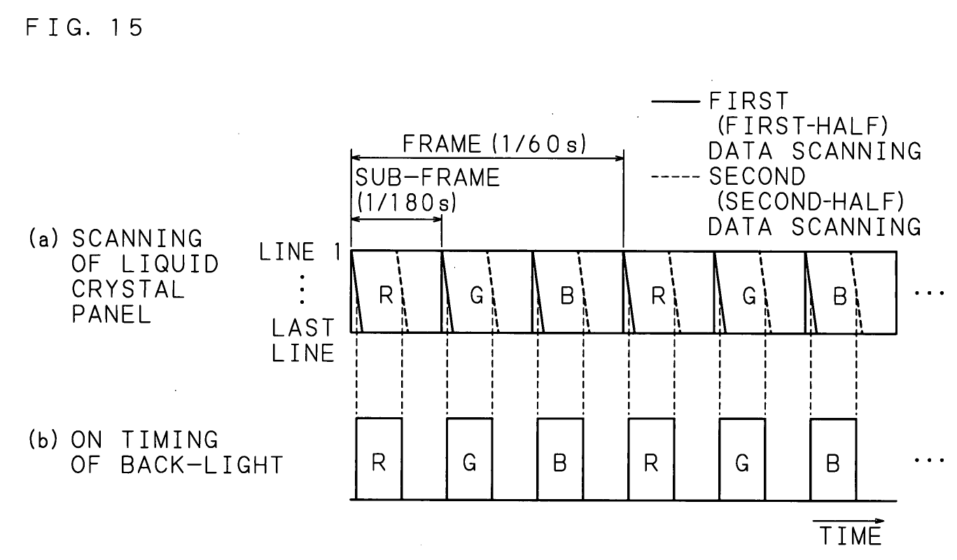

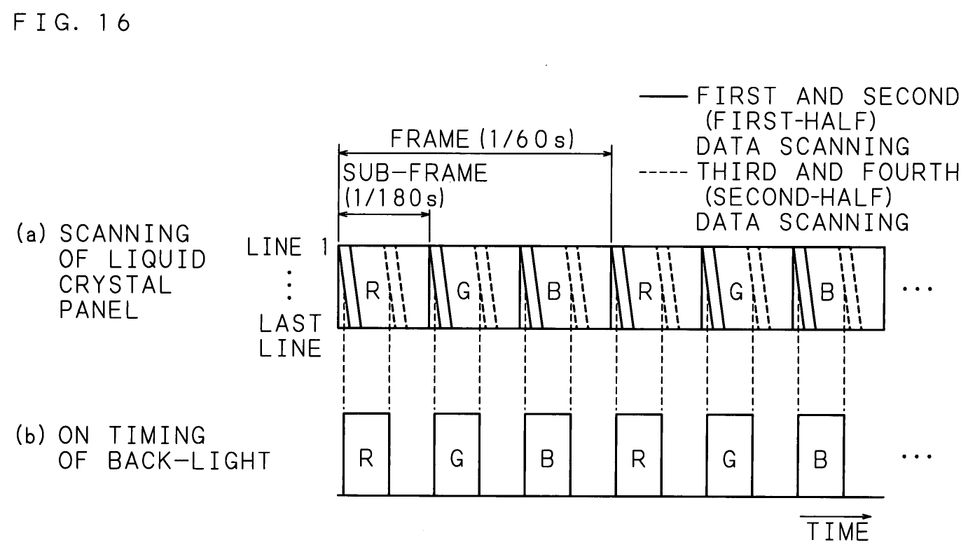

FIGS. 15 and 16 are illustrations showing examples of the drive sequence for such a case. The example shown in FIG. 15 is an improvement of the first or third embodiment (see FIG. 9), and the panel ON rate can be made higher than 88% by reducing the time required for each data scanning to be less than 25% of one sub-frame (1/180 s). Besides, the example shown in FIG. 16 is an improvement of the second or fourth embodiment (see FIG. 10), and the panel ON rate can be made higher than 88% by reducing the time required for each data scanning to be less than 25% of one sub-frame (1/180 s).

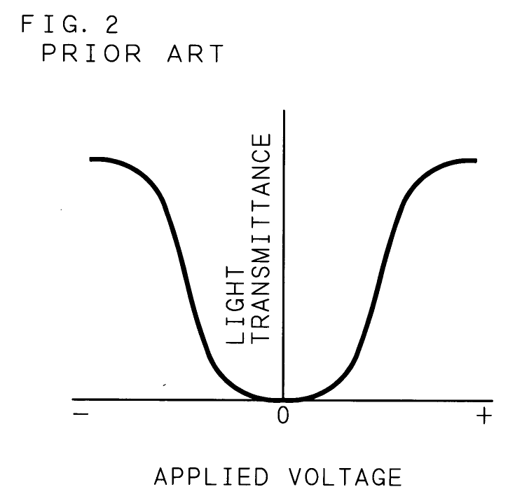

Note that although the above-described examples illustrate the cases where a liquid crystal material having half-V-shaped electro-optic response characteristics is used, it is of course possible to similarly apply the present invention to a case where a liquid crystal material having V-shaped electro-optic response characteristics shown in FIG. 2 is used. In such a case, in each sub-frame, the voltage applied to the liquid crystal of each pixel in one or a plurality of times of first-half data scanning and the voltage applied to the liquid crystal of each pixel in one or a plurality of times of second-half data scanning also have opposite polarities and substantially equal magnitude. However, since the liquid crystal material having V-shaped electro-optic response characteristics is used, a display with substantially equal brightness compared to the first-half data scanning can be obtained in the second-half data scanning.

In the above-described embodiments, the field-sequential type liquid crystal display devices are explained as examples, but the same effects can also be obtained for color-filter type liquid crystal display devices having color filters. The reason for this is that the present invention can be implemented similarly by applying the drive sequence for a sub-frame of the field-sequential method to a frame of the color-filter method.

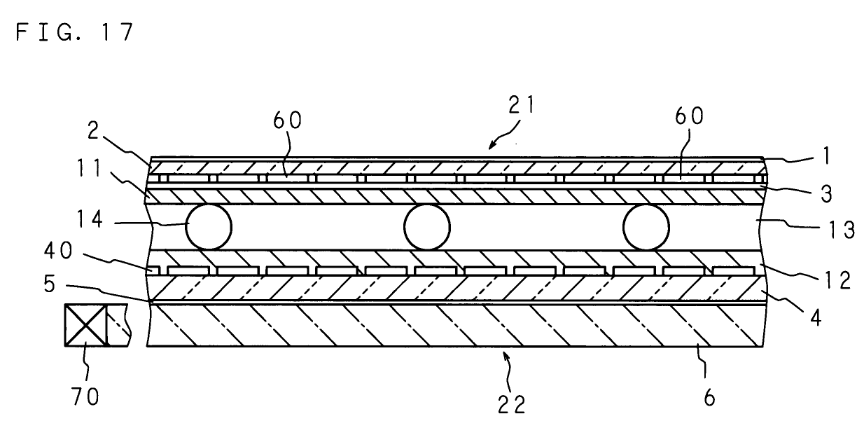

FIG. 17 is a schematic cross sectional view of the liquid crystal panel and back-light of a color-filter type liquid crystal display device. In FIG. 17, the same parts as in FIG. 7 are designated with the same numbers, and the explanation thereof is omitted. The common electrode 3 is provided with color filters 60 of the three primary colors (R, G, B). Besides, the back-light 22 is composed of a white light source 70 comprising one or a plurality of white light source elements for emitting white light, and a light guiding/diffusing plate 6. In such a color-filter type liquid crystal display device, a color display is performed by selectively transmitting white light emitted from the white light source 70 through the color filters 60 of a plurality of colors.

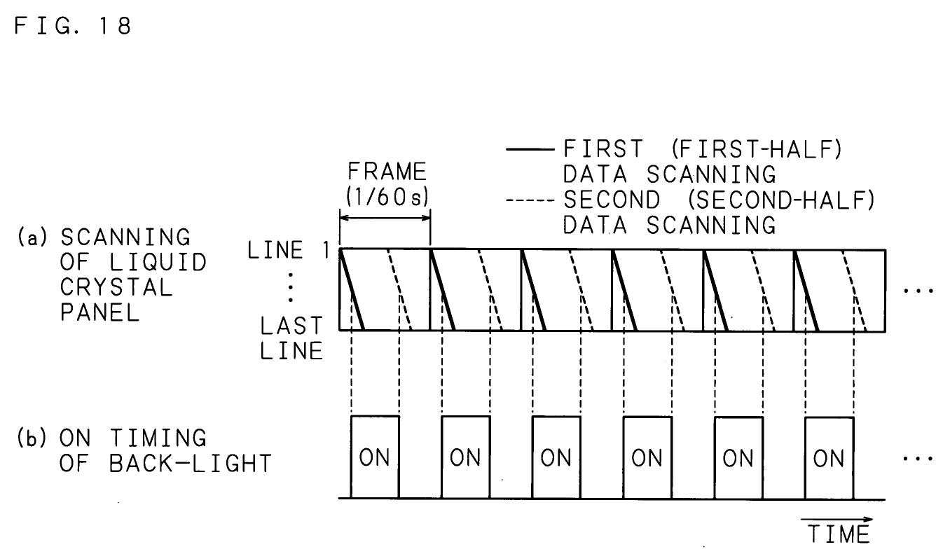

Further, even in the color-filter type liquid crystal display device, similarly to the above-described field-sequential type liquid crystal display devices, it is possible to provide the effects of improving the utilization efficiency of light from the back-light and reducing power consumption by performing a color display according to a drive sequence shown in FIG. 18 (in each frame, the back-light 22 is turned on between the intermediate timing in the first (first-half) data scanning and the intermediate timing in the second (second-hall) data scanning. In addition, it is of course possible to apply all the embodiments explained for the field-sequential method to a color-filter type liquid crystal display device.

As this invention may be embodied in several forms without departing from the spirit of essential characteristics thereof, the present embodiments are therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. A liquid crystal display device comprising:
a liquid crystal panel:
a light source for emitting light to be incident on said liquid crystal panel;
a synchronizing unit for synchronizing control of turning on said light source with data scanning based on image data to be displayed on said liquid crystal panel in each predetermined period; and
a control unit for turning on said light source between corresponding timings in respective beginning scanning of one or a plurality of times of first-half data scanning and one or a plurality of times of second-half data scanning within the predetermined period.

2. The liquid crystal display device of claim 1, wherein
the corresponding timing is a substantially intermediate time point in the respective beginning scanning.

3. The liquid crystal display device of claim 1, wherein
a voltage applied to said liquid crystal panel in one or a plurality of times of first-half data scanning and a voltage applied to said liquid crystal panel in one or a plurality of times of second-half data scanning are equal in magnitude and opposite in polarity.

4. The liquid crystal display device of claim 1, wherein
a darker display is obtained by one or a plurality of times of second-half data scanning compared to one or a plurality of times of first-half data scanning.

5. The liquid crystal display device of claim 1, wherein
a brightness distribution of said light source is uneven in a data scanning direction.

6. The liquid crystal display device of claim 5, wherein
the brightness of said light source is lowest in a center in the data scanning direction and increases from the center toward upstream and downstream in the data scanning direction.

7. The liquid crystal display device of claim 5, wherein
the brightness of said light source is lowest in a center in the data scanning direction, increases from the center toward upstream and downstream in the data scanning direction, and is higher on downstream side than on upstream side.

8. A liquid crystal display device comprising:
a liquid crystal panel:
a light source for emitting light to be incident on said liquid crystal panel;
a synchronizing unit for synchronizing control of turning on said light source with data scanning based on image data to be displayed on said liquid crystal panel in each predetermined period; and
a switching unit for making switching between a first method in which said light source is turned on between corresponding timings in respective beginning scanning of one or a plurality of times of first-half data scanning and one or a plurality of times of second-half data scanning within the predetermined period and a second method in which said light source is turned on between a start timing of beginning scanning of one or a plurality of times of first-half data scanning and an end timing of beginning scanning of one or a plurality of times of second-half data scanning within the predetermined period.

9. The liquid crystal display device of claim 1, wherein
a liquid crystal material for use in said liquid crystal panel has spontaneous polarization.

10. The liquid crystal display device of claim 8, wherein
a liquid crystal material for use in said liquid crystal panel has spontaneous polarization.

11. The liquid crystal display device of claim 1, wherein
said light source emits light of at least three primary colors, and a color display is performed by switching the color of light emitted by said light source in a time-divided manner in synchronism with ON/OFF driving of switching elements.

12. The liquid crystal display device of claim 8, wherein
said light source emits light of at least three primary colors, and a color display is performed by switching the color of light emitted by said light source in a time-divided manner in synchronism with ON/OFF driving of switching elements.

13. The liquid crystal display device of claim 1, wherein
said light source emits light of white color, and a color display is performed by selectively transmitting the light emitted from said light source through color filters of a plurality of colors.

14. The liquid crystal display device of claim 8, wherein
said light source emits light of white color, and a color display is performed by selectively transmitting the light emitted from said light source through color filters of a plurality of colors.
